(19) United States
(12) Patent Application Publication
(10) Pub. No.: US 2023/0120224 A1
(43) Pub. Date: Apr. 20, 2023

(54) PREDICTION MODEL TRAINING APPARATUS AND METHOD

(71) Applicant: INSTITUTE FOR INFORMATION INDUSTRY, TAIPEI (TW)

(72) Inventors: Chang En YANG, TAIPEI (TW); Ching Wen CHANG, TAIPEI (TW); Shu-Tzu HUANG, TAIPEI (TW); Chin-Wu LEE, TAIPEI (TW)

(21) Appl. No.: 17/647,345

(22) Filed: Jan. 6, 2022

(30) Foreign Application Priority Data
Oct. 15, 2021 (TW) 110138448

(51) Int. Cl. G06N 20/00

(52) U.S. Cl. CPC G06N 20/00

(57) ABSTRACT

A prediction model training apparatus and method are provided. The apparatus classifies a plurality of data into a normal situation data set and a non-normal situation data set, wherein each of the data comprises a plurality of first features. The apparatus trains a first prediction model based on the normal situation data set and a plurality of third features among the first features. The apparatus inputs the non-normal situation data set to the first prediction model to generate a first stage prediction value. The apparatus adds the first stage prediction value to the non-normal situation data set. The apparatus trains a second prediction model based on the non-normal situation data set and the first features.

### CROSS-REFERENCE TO RELATED APPLICATION

This application claims priority to Taiwan Application Serial Number 110138448, filed Oct. 15, 2021, which is herein incorporated by reference in its entirety.

### BACKGROUND

### Field of Invention

The present invention relates to a prediction model training apparatus and method. More particularly, the present invention relates to a prediction model training apparatus and method for improving the prediction accuracy of non-normal situations.

### Description of Related Art

In recent years, technologies and applications related to big data have developed rapidly. The supply chain of enterprises often builds prediction models to predict data of inventory consumption, purchase quantity, order quantity, sales quantity, etc.

However, there usually exists a small amount of irregular non-normal situations in actual data and data used for training prediction models, and thus occurs significant fluctuations. For example, non-normal situations such as the promotion event after the baseball game wins the championship, make-up workdays, start days, new holidays, unblocking of the epidemic, temporary short-term promotions, etc. Therefore, the prediction models of inventory consumption, purchase quantity, order quantity, and sales quantity of the enterprise supply chain are often affected by the non-normal situations and are not easy to predict the result. As a result, the accuracy of the prediction results is low and difficult to interpret, leading to inaccurate prediction models.

In addition, since the number of occurrences of non-normal situations is quite low, the available data on non-normal situations is scarce. Due to insufficient training data, it is difficult for enterprises to train prediction models for non-normal situations.

Accordingly, there is an urgent need for a technology that can improve the prediction accuracy of non-normal situations.

### SUMMARY

An objective of the present disclosure is to provide a prediction model training apparatus. The prediction model training apparatus comprises a storage, a transceiver interface, and a processor, and the processor is electrically connected to the storage and the transceiver interface. The processor classifies a plurality of data into a normal situation data set and a non-normal situation data set, wherein each of the data comprises a plurality of first features. The processor trains a first prediction model based on the normal situation data set and a plurality of third features among the first features. The processor inputs the non-normal situation data set to the first prediction model to generate a first stage prediction value. The processor adds the first stage prediction value to the non-normal situation data set. The processor trains a second prediction model based on the non-normal situation data set and the first features.

Another objective of the present disclosure is to provide a prediction model training method, which is adapted for use in an electronic apparatus. The electronic apparatus comprises a storage, a transceiver interface and a processor. The prediction model training method is performed by the processor. The prediction model training method comprises following steps: training a first prediction model based on a normal situation data set of a plurality of data and a plurality of third features of the data, wherein each of the data comprises a plurality of first features, and the third features are a part of the first features; inputting a non-normal situation data set of the data to the first prediction model to generate a first stage prediction value; adding the first stage prediction value to the non-normal situation data set; and training a second prediction model based on the non-normal situation data set and the first features.

According to the above descriptions, the prediction model training technology (at least including the apparatus and the method) provided by the present disclosure classifies a plurality of data into a normal situation data set and a non-normal situation data set in the first prediction model training stage, and trains a first prediction model based on the normal situation data set and a plurality of third features among the first features. In the second prediction model training stage, the prediction model training technology provided by the present disclosure inputs the non-normal situation data set to the first prediction model to generate a first stage prediction value, adds the first stage prediction value to the non-normal situation data set, and trains a second prediction model based on the non-normal situation data set and the first features. In the adjustment stage, the prediction model training technology provided by the present disclosure adjusts the time interval corresponding to the second feature multiple times based on a variety of different impact factors to generate different third prediction models and third prediction results corresponding to the third prediction models, and calculates a difference value of each of the third prediction results to determine an optimal impact factor and the third prediction model corresponding to the optimal impact factor.

The prediction model training technology provided by the present disclosure improves the accuracy of the prediction model for predicting non-normal situations based on three different stages of operations, and solves the problems that the prediction models produced by conventional technologies are often affected by non-normal situations. In addition, the present disclosure also adds the prediction value of the non-normal situation in the first stage to the training data of the second prediction model training stage, so that the prediction model of the second stage can have the model features of the normal situation, and solves the problems that the conventional technology lack of data to train the prediction model for non-normal situations.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic view depicting a prediction model training apparatus of the first embodiment;

FIG. 2 is a schematic view depicting the data of the first embodiment; and

FIG. 3 is a partial flowchart depicting a prediction model training method of the second embodiment.

### DETAILED DESCRIPTION

In the following description, a prediction model training apparatus and method according to the present disclosure will be explained with reference to embodiments thereof. However, these embodiments are not intended to limit the present disclosure to any environment, applications, or implementations described in these embodiments. Therefore, description of these embodiments is only for purpose of illustration rather than to limit the present disclosure. It shall be appreciated that, in the following embodiments and the attached drawings, elements unrelated to the present disclosure are omitted from depiction. In addition, dimensions of individual elements and dimensional relationships among individual elements in the attached drawings are provided only for illustration but not to limit the scope of the present disclosure.

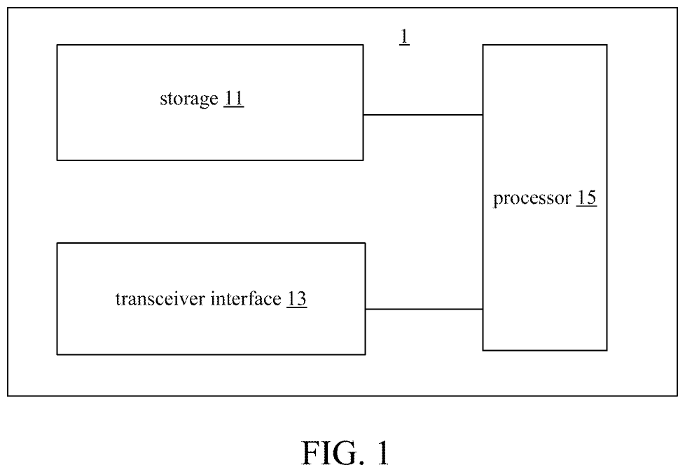

A first embodiment of the present disclosure is a prediction model training apparatus 1 and a schematic view of which is depicted in FIG. 1. The prediction model training apparatus 1 comprises a storage 11, a transceiver interface 13 and a processor 15, wherein the processor 15 is electrically connected to the storage 11 and the transceiver interface 13. The storage 11 may be a memory, a Universal Serial Bus (USB) disk, a hard disk, a Compact Disk (CD), a mobile disk, or any other storage medium or circuit known to those of ordinary skill in the art and having the same functionality. The transceiver interface 13 is an interface capable of receiving and transmitting data or other interfaces capable of receiving and transmitting data and known to those of ordinary skill in the art. The transceiver interface 13 can receive data from sources such as external apparatuses, external web pages, external applications, and so on. The processor 15 may be any of various processors, Central Processing Units (CPUs), microprocessors, digital signal processors or other computing apparatuses known to those of ordinary skill in the art.

The operations of the first embodiment of the present disclosure will be briefly described. The present disclosure mainly comprises two stages of operations: the first prediction model training stage and the second prediction model training stage. In some embodiments, the present disclosure further comprises an adjustment stage to optimize the prediction model. During the adjustment stage, the interval of the non-normal situation is adjusted to find the interval of the non-normal situation corresponding to the best prediction accuracy. The following paragraphs will describe the implementation details related to the present disclosure in detail.

First, the training data used to train the prediction model in the first prediction model training stage will be explained. In the present embodiment, the data used to train the prediction model is the number of a product in a plurality of time intervals, for example: the inventory consumption per week (i.e., the unit is a week).

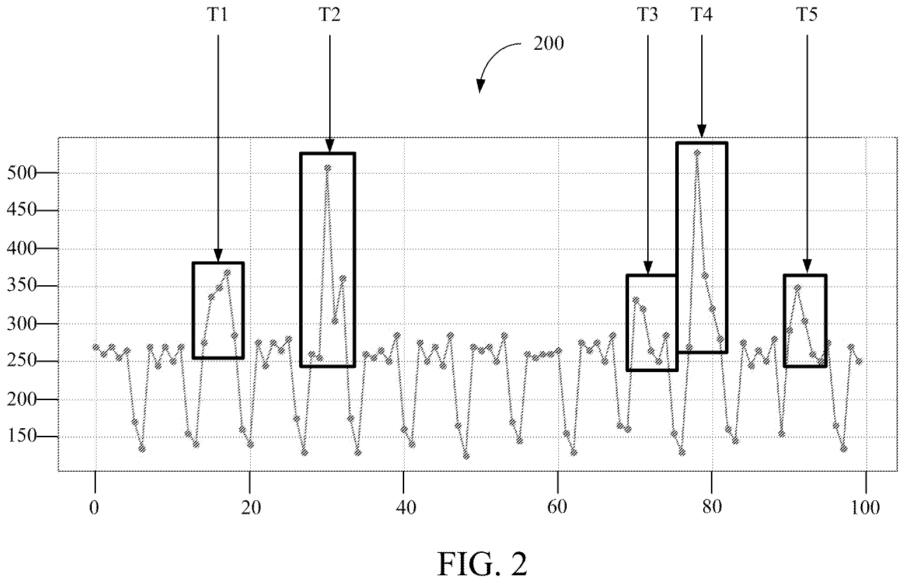

For ease of understanding, a specific example will be used as an example below, please refer to FIG. 2. FIG. 2 illustrates the numerical fluctuations of the data 200 about the inventory consumption of beverage A. In FIG. 2, the value of the X-axis is the number of the week (unit: week), and the value of the Y-axis is the amount of inventory consumption (unit: piece). Each data point represents the amount of inventory consumption of the week. The data 200 records a total of 100 weeks of inventory consumption transaction data.

It shall be appreciated that FIG. 2 is only used to illustrate one embodiment of the data. In some embodiments, other kinds of data can also be used, the parameters such as purchase quantity, order quantity, sales quantity, etc. can be the training data of the prediction model, which depends on the use and scale of the prediction model. Those of ordinary skill in the art shall appreciate the content of other embodiments based on the foregoing descriptions. Therefore, the details will not be repeated herein.

In the present embodiment, the data of each data point in the data 200 (i.e., each data point in FIG. 2) further comprises a plurality of features (not shown), and each feature corresponds to a feature item and parameter values corresponding to the feature item. It shall be appreciated that, in order to facilitate the description and identification of the features used in different stages of the present disclosure, in the following paragraphs, “first feature” will be used to refer to each feature included in each data point in the data 200.

For example, each data point in the data 200 further records four first features such as “working day”, “temperature”, “promotional event” and “advertising”. For another example, the parameter value corresponding to the first feature of “working day” may be “number of working days in the week”, and the parameter value corresponding to the first feature of “temperature” may be “average temperature of the week” or “the temperature fluctuation value of the week”, the parameter value corresponding to the first feature of “promotional event” may be “type of promotional event” (e.g., buy two items at a time with 50% off, buy three items and get one item for free, etc.), the parameter value corresponding to the first feature of “advertising” may be “type of advertising” or “time length of advertising”. It shall be appreciated that the present disclosure does not limit the types of the first features and the corresponding parameter value types, and any data that can assist in training the prediction model should be within the protection scope of the present disclosure.

Next, the establishment operations of the first prediction model in the first prediction model training stage will be described in detail. In the present embodiment, in order to more accurately distinguish the influence degree of each data point in the data 200, the processor 15 first classifies the data 200 into different data sets. Specifically, the processor 15 executes the operation (a) to classify a plurality of data into a normal situation data set and a non-normal situation data set, wherein each of the data comprises a plurality of first features.

For example, the normal situation data set can be expressed by the following equation:

D₁={(yₙ_{ᵢ},xₙ_{ᵢ})}_{i∈{1, . . . , N}_{₁}}

In the above equation, D₁ is the normal situation data set, the parameter yₙ_{ᵢ} represents the prediction target (i.e., each data point), the parameter xₙ_{ᵢ} represents the first features, and the parameter N₁ is the number of data.

For example, the non-normal situation data set can be expressed by the following equation:

D₂={(yₘ_{ᵢ},xₘ_{ᵢ})}_{i∈{1, . . . , N}_{₂}}

In the above equation, D₂ is the non-normal situation data set, the parameter yₘ_{ᵢ} represents the prediction target (i.e., each data point), the parameter xₘ_{ᵢ} represents the first features, and the parameter N₂ is the number of data.

In some embodiments, the processor 15 selects a part of the first features as the second feature to classify the data based on the second feature (i.e., use the second feature to classify the interval of the non-normal situation to be predicted). Specifically, the processor 15 classifies the data into the normal situation data set and the non-normal situation data set based on a time interval corresponding to the second feature, wherein the second feature is one of the first features.

For example, if the “promotional event” in the first feature is used as the second feature, the processor 15 classifies the data points with the same “promotional event” feature. As shown in FIG. 2, the processor 15 classifies data points in the data 200 that have the same feature of “promotional event”, and their corresponding time intervals are T1, T2, T3, T4, and T5 (i.e., data points within the time interval have the feature of the “promotional event”). In other words, the data points of the non-normal situation data set are the data points in the time intervals T1, T2, T3, T4, and T5, and the remaining data points are classified into the normal situation data set.

In the above example, since the “promotional event” usually corresponds to a fixed time interval, for example: the “promotional event” lasts 5 weeks, and thus each time interval T1, T2, T3, T4, and T5 in FIG. 2 is composed of 5 data points. In other embodiments, the non-normal situation data set may also be composed of non-fixed time intervals, depending on the different features. Those of ordinary skill in the art shall appreciate the implementation of non-fixed time intervals based on the foregoing descriptions. Therefore, the details will not be repeated herein.

Next, the processor 15 selects a feature related to the prediction target (hereinafter referred to as a third feature) from the first features to train the first prediction model. Specifically, the processor 15 executes operation (b) to train a first prediction model based on the normal situation data set and a plurality of third features among the first features.

In some embodiments, the processor 15 filters the first features before training the first prediction model to exclude some features that are not related to the second feature (i.e., the numerical fluctuations corresponding to the features are relatively irrelevant to the numerical fluctuations corresponding to the second feature in the time interval), so as to avoid some irrelevant features from affecting the training results of the prediction model. Specifically, the processor 15 performs a correlation analysis on the first features based on the second feature to select a part of the first features as the third features.

Continuing the aforementioned example, for example, if the processor 15 uses the “promotional event” in the first features as the second feature, the processor 15 performs the correlation analysis on these first features (i.e., determine the features of the first features that are related to the “promotional event”) based on the “promotional event” selected as the second feature. In the present example, the processor 15 determines that among the first features that are more relevant to the second feature “promotional event” are “working days” and “temperature” (e.g., the number of working days of the week and the average temperature of the week may affect the value of the interval corresponding to the “promotional event”. Therefore, the fluctuation of the number of days of the “working day” and the fluctuation of the value of the “temperature” are more relevant to the effect of the “promotional event”). Hence, the processor 15 selects the “working day” and the “temperature” in the first features as the third features, and these third features will be used to train the prediction model in subsequent operations.

In some embodiments, before training the first prediction model, the processor 15 further performs a regularization operation on the third features in the normal situation data to reduce the occurrence of overfitting. It shall be appreciated that after the processor 15 performs a regularization operation on the third features of the normal situation data, the processor 15 generates a weight value corresponding to each of the third features, and the weight values of the third features will be used to train the first prediction model. It shall be appreciated that those of ordinary skill in the art shall appreciate the operations of training the first prediction model through the weight values based on the foregoing descriptions. Therefore, the details will not be repeated herein.

For example, the regularization objective function can be expressed by the following formula:

$${w}_{1} = {argmin}_{\begin{matrix}w ∈ {ℝ}^{Q} \\ {w}^{T} w < {C}_{1}\end{matrix}} {E}_{i n}^{( 1 )} ( w ) \qquad ( 1 )$$

In the above formula, w₁ is the weight value corresponding to the third features in the first stage, w is the weight value corresponding to each third feature, w^{T}w<C₁ is the regularization rule, Eᵢₙ⁽¹⁾ is the result of regularization in the first stage.

It shall be appreciated that the first prediction model can be trained through a large amount of input data, and the machine learning can be performed through various known architectures (such as neural networks). Those of ordinary skill in the art shall appreciate the operations of training the first prediction model based on the foregoing descriptions. Therefore, the details will not be repeated herein.

Next, the following paragraphs will specifically describe the establishment operations of the second prediction model in the second prediction model training stage. In the present stage, the processor 15 uses the prediction model built by the normal situation (i.e., the first prediction model) to predict the value of the interval of the non-normal situation, and adds the prediction result to the training data, so that the training data of the second stage comprises the model features of the first stage, which enhances the ability of the second prediction model generated in the second stage to predict the non-normal situations.

First, the processor 15 executes operation (c) to input the non-normal situation data set into the first prediction model to generate a first stage prediction value. Then, the processor 15 executes operation (d) to add the first stage prediction value to the non-normal situation data set, so that the non-normal situation data set comprises the first stage prediction value. Finally, the processor 15 executes operation (e) to train a second prediction model based on the non-normal situation data set and the first features.

In some embodiments, the first stage prediction value comprises a plurality of time intervals and a prediction value corresponding to each of the time intervals. For example, the prediction value may be predicted inventory consumption, predicted purchase quantity, predicted order quantity, predicted sales quantity, and so on.

In some embodiments, before training the second prediction model, the processor 15 further performs a regularization operation on the first features in the non-normal situation data to reduce the occurrence of overfitting. It shall be appreciated that after the processor 15 performs a regularization operation on the first features of the non-normalsituation data, the processor 15 generates a weight values corresponding to each of the first features, and the weight values of the first features will be used to train the second prediction model.

In some embodiments, in addition to the regularization operation, the processor 15 preferentially uses the third feature that was not used in the first training stage when training the second prediction model (i.e., reducing the use of the weight of the third feature used in the first training stage). This operation can focus on strengthening the feature relative to the non-normal situation, thereby reducing the feature dimension and improving the performance when training the prediction model. Specifically, the processor 15 reduces a weight corresponding to each of the third features among the first features, and the processor 15 trains the second feature model based on the non-normal situation data set, the first features, and the weights.

For example, the objective function of the second stage regularization can be expressed by the following formula:

$${w}_{2} = {argmin}_{\begin{matrix}w ∈ {ℝ}^{Q} \\ {w}^{T} w < {C}_{1} , \vert ( 0 , {w}_{1}^{T} ) w \vert < {C}_{2}\end{matrix}} {E}_{i n}^{( 2 )} ( w ) \qquad ( 2 )$$

In the above formula, w₂ is the weight value corresponding to the first features in the second stage, w is the weight value corresponding to each first feature, w^{T}w<C₁ and |(0, w₁^{T})w|<C₂ is the regularization rule, and Eᵢₙ⁽²⁾ is the result of the second stage regularization.

In addition, it shall be appreciated that the time interval affected by certain features is not only limited to the time interval with the second feature, (e.g., promotional events or advertising), and there will be an early or delayed impact effect, so the time interval of the impact will be earlier or extended, for example: one week after the end of the advertising, the sales quantity still maintains at a high level. Therefore, in some embodiments, after training the second prediction model, the processor 15 further adjusts the influence range of the time interval to find the best time interval affected by the non-normal situation. The following paragraphs will specifically describe the operating process of the adjustment phase.

In some embodiments, the processor 15 further adjusts the range of the time interval based on the impact factor r, and trains a new prediction model based on the adjusted time interval. For example, when the impact factor r is set to “one week”, the original time interval T is extended by one week before and after the time point. In other words, if the time interval T originally corresponding to a certain feature is composed of time points a and b, the processor 15 expands the time interval T to a new time interval “T” composed of time points “a−r” and time points “b+r”.

Specifically, after performing the aforementioned the operation (b), the operation (c), the operation (d), and the operation (e), the processor 15 further performs the operation (a2) to adjust the time interval corresponding to the second feature based on an impact factor. Next, the processor 15 further performs the operation (a3) to classify the normal situation data set and the non-normal situation data set based on the time interval. Then, the processor 15 further performs the operation (f) to perform the operation (b), the operation (c), the operation (d), and the operation (e) to train a third prediction model.

In some embodiments, the processor 15 further adjusts the time interval multiple times (i.e., adjusts the impact factor r), generates a plurality of new prediction models trained based on different impact factors r, and compares each prediction model to find the best time interval and impact factor r affected by non-normal situations. For example, the processor 15 can use root-mean-square error (RMSE) to calculate the deviation of the root-mean-square error of the prediction value of the non-normal situation interval corresponding to different impact factors r (i.e., comparing the prediction result of the prediction model of multiple different impact factors).

Specifically, the processor 15 further executes operation (g) to repeatedly perform the operation (a2), the operation (a3), and the operation (f) for n times to train n third prediction models, wherein n is a positive integer. Then, the processor 15 executes operation (h) to generate a third prediction result corresponding to each of the third prediction models based on each of the third prediction models. Finally, the processor 15 executes operation (i) to calculate a difference value of each of the third prediction results to determine an optimal impact factor and the third prediction model corresponding to the optimal impact factor.

According to the above descriptions, the prediction model training apparatus provided by the present disclosure classifies a plurality of data into a normal situation data set and a non-normal situation data set in the first prediction model training stage, and trains a first prediction model based on the normal situation data set and a plurality of third features among the first features. In the second prediction model training stage, the prediction model training apparatus provided by the present disclosure inputs the non-normal situation data set to the first prediction model to generate a first stage prediction value, adds the first stage prediction value to the non-normal situation data set, and trains a second prediction model based on the non-normal situation data set and the first features. In the adjustment stage, the prediction model training apparatus provided by the present disclosure adjusts the time interval corresponding to the second feature multiple times based on a variety of different impact factors to generate different third prediction models and third prediction results corresponding to the third prediction models, and calculates a difference value of each of the third prediction results to determine an optimal impact factor and the third prediction model corresponding to the optimal impact factor.

The prediction model training technology provided by the present disclosure improves the accuracy of the prediction model for predicting non-normal situations based on three different stages of operations, and solves the problems that the prediction models produced by conventional technologies are often affected by non-normal situations. In addition, the present disclosure also adds the prediction value of the non-normal situation in the first stage to the training data of the second prediction model training stage, so that the prediction model of the second stage can have the model features of the normal situation, and solves the problems that the conventional technology lack of data to train the prediction model for non-normal situations.

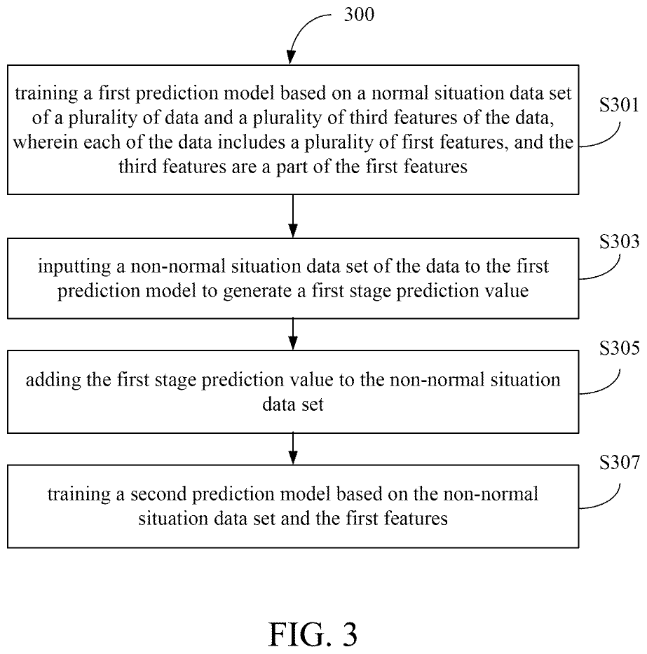

A second embodiment of the present disclosure is a prediction model training method and a flowchart thereof is depicted in FIG. 3. The prediction model training method 300 is adapted for an electronic apparatus, and the electronic apparatus comprises a storage, a transceiver interface and a processor (e.g., the prediction model training apparatus 1 of the first embodiment). The prediction model training method trains the prediction model through the steps S301 to S307.

In the step S301, the electronic apparatus trains a first prediction model based on a normal situation data set of a plurality of data and a plurality of third features of the data, wherein each of the data comprises a plurality of first features, and the third features are a part of the first features. In the step S303, the electronic apparatus inputs a non-normal situation data set of the data to the first prediction model to generate a first stage prediction value.

In some embodiments, the prediction model training method 300 further comprises following steps: classifying the data into the normal situation data set and the non-normal situation data set based on a time interval corresponding to a second feature, wherein the second feature is one of the first features.

In some embodiments, the prediction model training method 300 further comprises following steps: performing a correlation analysis on the first features based on the second feature to select a part of the first features as the third features.

In some embodiments, the first stage prediction value comprises a plurality of time intervals and a prediction value corresponding to each of the time intervals.

Next, in the step S305, the electronic apparatus adds the first stage prediction value to the non-normal situation data set. Finally, in the step S307, the electronic apparatus trains a second prediction model based on the non-normal situation data set and the first features.

In some embodiments, the step S307 further comprises the following steps: (d1) reducing a weight corresponding to each of the third features among the first features; and (d2) training the second prediction model based on the non-normal situation data set, the first features, and the weights.

In some embodiments, the prediction model training method 300 further comprises following steps: (a1) adjusting the time interval corresponding to the second feature based on an impact factor; (a2) classifying the normal situation data set and the non-normal situation data set based on the time interval; and (e) performing the step (a), the step (b), the step (c), and the step (d) to train a third prediction model.

In some embodiments, the prediction model training method 300 further comprises following steps: (f) repeatedly performing the step (a1), the step (a2), and the step (e) for n times to train n third prediction models, wherein n is a positive integer; (g) generating a third prediction result corresponding to each of the third prediction models based on each of the third prediction models; and (h) calculating a difference value of each of the third prediction results to determine an optimal impact factor and the third prediction model corresponding to the optimal impact factor.

In addition to the aforesaid steps, the second embodiment can also execute all the operations and steps of the prediction model training apparatus 1 set forth in the first embodiment, have the same functions, and deliver the same technical effects as the first embodiment. How the second embodiment executes these operations and steps, has the same functions, and delivers the same technical effects will be readily appreciated by those of ordinary skill in the art based on the explanation of the first embodiment. Therefore, the details will not be repeated herein.

It shall be appreciated that in the specification and the claims of the present disclosure, some words (e.g., the feature and the prediction model) are preceded by terms such as “first”, “second”, and “third”, and these terms of “first”, “second”, and “third” are only used to distinguish these different words. For example, the “first”, “second”, and “third” features are only used to indicate the features used in different operations.

According to the above descriptions, the prediction model training technology (at least including the apparatus and the method) provided by the present disclosure classifies a plurality of data into a normal situation data set and a non-normal situation data set in the first prediction model training stage, and trains a first prediction model based on the normal situation data set and a plurality of third features among the first features. In the second prediction model training stage, the prediction model training technology provided by the present disclosure inputs the non-normal situation data set to the first prediction model to generate a first stage prediction value, adds the first stage prediction value to the non-normal situation data set, and trains a second prediction model based on the non-normal situation data set and the first features. In the adjustment stage, the prediction model training technology provided by the present disclosure adjusts the time interval corresponding to the second feature multiple times based on a variety of different impact factors to generate different third prediction models and third prediction results corresponding to the third prediction models, and calculates a difference value of each of the third prediction results to determine an optimal impact factor and the third prediction model corresponding to the optimal impact factor.

The prediction model training technology provided by the present disclosure improves the accuracy of the prediction model for predicting non-normal situations based on three different stages of operations, and solves the problems that the prediction models produced by conventional technologies are often affected by non-normal situations. In addition, the present disclosure also adds the prediction value of the non-normal situation in the first stage to the training data of the second prediction model training stage, so that the prediction model of the second stage can have the model features of the normal situation, and solves the problems that the conventional technology lack of data to train the prediction model for non-normal situations.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the invention. In view of the foregoing, it is intended that the present disclosure cover modifications and variations of this invention provided they fall within the scope of the following claims.

What is claimed is:

1. A prediction model training apparatus, comprising:
a storage;
a transceiver interface; and
a processor, being electrically connected to the storage and the transceiver interface, and being configured to perform following operations:
(a) classifying a plurality of data into a normal situation data set and a non-normal situation data set, wherein each of the data comprises a plurality of first features;
(b) training a first prediction model based on the normal situation data set and a plurality of third features among the first features;
(c) inputting the non-normal situation data set to the first prediction model to generate a first stage prediction value;
(d) adding the first stage prediction value to the non-normal situation data set; and
(e) training a second prediction model based on the non-normal situation data set and the first features.

2. The prediction model training apparatus of claim 1, wherein the first stage prediction value comprises a plurality of time intervals and a prediction value corresponding to each of the time intervals.

3. The prediction model training apparatus of claim 1, wherein the operation (e) further comprises following operations:
(e1) reducing a weight corresponding to each of the third features among the first features; and
(e2) training the second prediction model based on the non-normal situation data set, the first features, and the weights.

4. The prediction model training apparatus of claim 1, wherein the operation (a) further comprises following operations:
(a1) classifying the data into the normal situation data set and the non-normal situation data set based on a time interval corresponding to a second feature, wherein the second feature is one of the first features.

5. The prediction model training apparatus of claim 4, wherein the operation (b) further comprises following operations:
(b1) performing a correlation analysis on the first features based on the second feature to select a part of the first features as the third features.

6. The prediction model training apparatus of claim 4, wherein the processor further performs following operations:
(a2) adjusting the time interval corresponding to the second feature based on an impact factor;
(a3) classifying the normal situation data set and the non-normal situation data set based on the time interval; and
(f) performing the operation (b), the operation (c), the operation (d), and the operation (e) to train a third prediction model.

7. The prediction model training apparatus of claim 6, wherein the processor further performs following operations:
(g) repeatedly performing the operation (a2), the operation (a3), and the operation (f) for n times to train n third prediction models, wherein n is a positive integer;
(h) generating a third prediction result corresponding to each of the third prediction models based on each of the third prediction models; and
(i) calculating a difference value of each of the third prediction results to determine an optimal impact factor and the third prediction model corresponding to the optimal impact factor.

8. The prediction model training apparatus of claim 1, wherein the processor further performs a regularization operation on the third features in the normal situation data.

9. The prediction model training apparatus of claim 1, wherein the processor further performs following operations:
(a1) classifying the data into the normal situation data set and the non-normal situation data set based on a time interval corresponding to a second feature, wherein the second feature is one of the first features;
(e1) reducing a weight corresponding to each of the third features among the first features; and
(e2) training the second prediction model based on the non-normal situation data set, the first features, and the weights.

10. The prediction model training apparatus of claim 1, wherein the processor further performs following operations:
(a1) classifying the data into the normal situation data set and the non-normal situation data set based on a time interval corresponding to a second feature, wherein the second feature is one of the first features;
(b1) performing a correlation analysis on the first features based on the second feature to select a part of the first features as the third features;
(e1) reducing a weight corresponding to each of the third features among the first features; and
(e2) training the second prediction model based on the non-normal situation data set, the first features, and the weights.

11. A prediction model training method, being adapted for use in an electronic apparatus, wherein the electronic apparatus comprises a storage, a transceiver interface and a processor, and the prediction model training method is performed by the processor and comprises following steps:
(a) training a first prediction model based on a normal situation data set of a plurality of data and a plurality of third features of the data, wherein each of the data comprises a plurality of first features, and the third features are a part of the first features;
(b) inputting a non-normal situation data set of the data to the first prediction model to generate a first stage prediction value;
(c) adding the first stage prediction value to the non-normal situation data set; and
(d) training a second prediction model based on the non-normal situation data set and the first features.

12. The prediction model training method of claim 11, wherein the first stage prediction value comprises a plurality of time intervals and a prediction value corresponding to each of the time intervals.

13. The prediction model training method of claim 11, wherein the step (d) further comprises the following steps:
(d1) reducing a weight corresponding to each of the third features among the first features; and
(d2) training the second prediction model based on the non-normal situation data set, the first features, and the weights.

14. The prediction model training method of claim 11, wherein the prediction model training method further comprises following steps:
classifying the data into the normal situation data set and the non-normal situation data set based on a time interval corresponding to a second feature, wherein the second feature is one of the first features.

15. The prediction model training method of claim 14, wherein the prediction model training method further comprises following steps:
performing a correlation analysis on the first features based on the second feature to select a part of the first features as the third features.

16. The prediction model training method of claim 14, wherein the prediction model training method further comprises following steps:
(a1) adjusting the time interval corresponding to the second feature based on an impact factor;
(a2) classifying the normal situation data set and the non-normal situation data set based on the time interval; and
(e) performing the step (a), the step (b), the step (c), and the step (d) to train a third prediction model.

17. The prediction model training method of claim 16, wherein the prediction model training method further comprises following steps:
(f) repeatedly performing the step (a1), the step (a2), and the step (e) for n times to train n third prediction models, wherein n is a positive integer;
(g) generating a third prediction result corresponding to each of the third prediction models based on each of the third prediction models; and
(h) calculating a difference value of each of the third prediction results to determine an optimal impact factor and the third prediction model corresponding to the optimal impact factor.

18. The prediction model training method of claim 11, wherein the prediction model training method further comprises following steps:
performing a regularization operation on the third features in the normal situation data.

19. The prediction model training method of claim 11, wherein the prediction model training method further comprises following steps:
classifying the data into the normal situation data set and the non-normal situation data set based on a time interval corresponding to a second feature, wherein the second feature is one of the first features;
reducing a weight corresponding to each of the third features among the first features; and
training the second prediction model based on the non-normal situation data set, the first features, and the weights.

20. The prediction model training method of claim 11, wherein the prediction model training method further comprises following steps:
classifying the data into the normal situation data set and the non-normal situation data set based on a time interval corresponding to a second feature, wherein the second feature is one of the first features;
performing a correlation analysis on the first features based on the second feature to select a part of the first features as the third features
reducing a weight corresponding to each of the third features among the first features; and
training the second prediction model based on the non-normal situation data set, the first features, and the weights.
